(19) United States
(12) Patent Application Publication
(10) Pub. No.: US 2005/0112246 A1
(43) Pub. Date: May 26, 2005

(54) Food product and support stick therefor

(76) Inventor: Allan A. Corrin, Reedley, CA (US)

Correspondence Address: Richard A. Ryan;RYAN & ENGNATH, Suite 104, 8469 N. Millbrook, Fresno, CA, 93720, US

(21) Appl. No.: 10/719,081

(22) Filed: Nov. 21, 2003

(51) Int. Cl. A23G 1/00

(52) U.S. Cl. 426/134

(57) ABSTRACT

A food product made from a support stick that is configured to inserted into and securely hold food items having a central core section such as stone fruits and pome fruits. The food items can be fresh, frozen or dried. The support stick has an upper section with two or more upwardly extending arms configured to securely hold the central core section in a chamber formed by the arms and a lower section forming a handle. The arms can be elastic to expand and then contract around the central core section and have one or more grasping members, such as barbs, to prevent the arms from being disengaged from the central core section while eating the food product. The grasping members can be generally downwardly directed to ease entry of the arms into the food item. A method of making the food product is also presented.

### CROSS-REFERENCE TO RELATED APPLICATIONS

Not Applicable.

### BACKGROUND OF THE INVENTION

A. Field of the Invention

The field of the present invention relates generally to food products and support members used to support the food item of the product. More specifically, the present invention relates to food products configured to be eaten on a stick or stick-like support member and to such support members that are used to hold the food item while being eaten. Even more specifically, the present invention relates to a support stick that is configured to securely grasp the inner portion, such as the pit, of a food item to allow the fresh, frozen or dried food product to be easily eaten.

B. Background

Food products having a stick or stick-like support member inserted therein for ease of serving and eating the food product have been available for a long time. For instance, ice cream, popsicles, frozen yogurt, frozen fruit bars and the like have been available for many years. It has also been known to utilize stick-like support members to support fresh or frozen fruit, such as bananas, strawberries, and apples, some of which are dipped into chocolate, caramel or other edible coatings. The typical support member for such products is a wooden or plastic stick having an upper section with a rounded (i.e., popsicle stick) or sharp top end for insertion into the food item and a lower section suitable for a handle to hold onto while eating the food item. For frozen food products such as ice cream, frozen yogurt and the like, the food item is generally frozen around the stick such that an integral food product is formed. For other food items, such as fresh fruit, the upper section of the support stick is inserted into the fruit and the lower section extends out of the fruit. Naturally, the support stick must be inserted far enough into the food item so that it will sufficiently hold the food product while the food item is being eaten.

In addition to the typical popsicle stick or pointed end stick utilized for food products, various other support members are known to exist. For instance U.S. Pat. No. 3,950,548 to Baker describes an ice cream and fruit confectionery product that utilizes a stick having a handle portion and a seat portion configured to receive a fruit item with a center core thereof filled with ice cream or the like. The confectionery product is formed by removing a core portion from the fruit to form a hole therein, mounting the fruit onto the stick and then filling the hole with ice cream or other product. U.S. Pat. No. 3,459,296 to Berg describes a receptacle and support for frozen confection that comprises an open top container attached to a handle extending from the closed bottom of the container. The frozen confection, such as ice cream, is placed inside the open container so the user can hold the handle while eating the frozen confection. U.S. Pat. No. 2,929,721 to Mitzenmacher describes a generally dish-shaped container, for receiving ice cream or the like, with a handle member that is able to be retracted inside a portion of the container for ease of shipping and then pulled out to use as a handle for eating the ice cream.

Most stick-type of food products are the desert type of confectionery, such as ice cream bars and the like. Even some of these products that claim to be more “healthy” than desert, still contain mostly processed sugar and water and, occasionally, a small percentage of fruit juice or fruit based products. However, today's society has become more concerned with the health aspects of the foods they consume. This is particularly true when it comes to children and, more specifically, the food that is available to them when they are away from home at school. Because of this, more and more schools are removing candy and soda machines from their premises, often in response to criticism from parents and health related organizations. What is needed are healthy snacks to replace the “junk food” that is currently available. While fresh, dried or frozen fruit have certain advantages with regard to being generally healthy to eat, they do not have the convenience or novelty of a ice cream bar or other stick-based confectioneries. Having a food product that is easy, fun and healthy to eat is desired by many.

Although the standard popsicle stick, pointed stick and the above-referenced support members work well for ice cream, yogurt, frozen fruit bars and certain types of fruits, they do not work very well with fruits or other food items having a solid or semi-solid center portion, particularly a hard inner portion such as a pit or the like. Fruit having a hard inner pit surrounded by the fleshy fruit portion are generally referred to as stone fruit, and include such fruit as peaches, nectarines, plums, cherries and apricots. Other fruit, commonly referred to as pome fruit, which includes apples and pears, have a fleshy fruit portion with seeds and generally united carpels at the core of the fruit. Due to the pit in stone fruit and, to a lesser extent, the united carpels in the pome fruit, the standard stick support members are not able to be inserted very far into the fruit and, as a result, generally do not function well with these fruits. This is particularly the case with the hard center pit of the stone fruit, which results in the stick not going in far enough to provide sufficient stability to eat the fleshy fruit portion. Even in the Baker patent, which suggests utilizing a peach as the fruit portion of the product, the peach is cored along its center axis to remove the peach pit. With stone fruit, if the pit is left in the fruit, the upper end of the stick support member will hit against the pit, leaving an insufficient amount of the support member encased by the fleshy fruit portion. As a result, eating of the fruit around the support member is likely to result in the fruit falling off the stick.

What is needed, therefore, is a new food product and a support stick for use with the food product that allows use with stone fruit and other types of foods that do not function well with currently available support members. The preferred support stick should be suitable for use with stone fruits, pome fruits and other food items that have a pit or center core portion that makes use of presently available stick members undesirable. The support stick should be able to be easily attached to the food item and be able to securely hold the food item on the support stick, even while the food item is being eaten around the stick and center portion of the food item. Preferably, the support stick should be difficult to dislodge from the food item while there is still food item around the core section. It is also preferred that such a support stick should be relatively inexpensive to manufacture and simple to utilize.

### SUMMARY OF THE INVENTION

The food product and support stick therefor of the present invention solves the problems and provides the benefits identified above. That is to say, the present invention discloses a food product that is easy, fun and healthy to eat and an improved support stick for stone fruit and other food items having a center core section, such as a pit, that is particularly configured to securely hold the center core section while the edible portion of the food item is being eaten. An upper section of the support stick of the present invention extends upwardly into the food item to grab onto the center core section of the food item and a lower section of the support stick extends outwardly from the food item to be utilized as a handle while eating the edible portion of the food item. In the preferred embodiment, the improved support stick is used with various foods to form a new food product that can be eaten in the same or similar manner as other presently available stick handled food products (i.e., ice cream bars and the like). The improved support stick of the present invention can be made very economically, can be easily inserted into various food items and is effective at securely holding onto the food item while it is being eaten by the consumer.

For purposes of this disclosure, the term “food item” includes foods that are suitable for placement on the support stick of the present invention. In particular, the term food item includes those foods that have a center core section that makes presently available support sticks difficult, if not impossible, to utilize. These food items include stone fruit having a generally hard and centrally disposed pit surrounded by the fleshy edible portion of the fruit and pome fruit having a defined central core. Food items include the fresh, frozen and dried versions of these fruit, with the center core section still intact, as well as any reconstituted versions of these fruit (i.e., where the edible portion is separated from the center core section and any seeds and then ground up to form a fruit based product). If desired, food item also includes foods other than fruits that can be placed onto and eaten from the support stick of the present invention.

In one aspect of the present invention, the improved support stick for food items having a central core section, including fresh, frozen and dried food items, has an upper section and a lower section. The upper section has two or more generally upwardly extending arms that form a chamber therebetween. The arms are configured to be inserted into the food item and securely grasp the central core section thereof. The lower section abuts the upper section and at least a portion of the lower section extends outwardly from the food item to form a handle. The food item can be stone fruits, pome fruits or other food items. In the preferred embodiment, the arms are elastic such that they expand and then contract around the central core section when the upper section is inserted into the food item. Also in the preferred embodiment, the arms have a plurality of generally inwardly and downwardly projecting grasping members that are configured to not substantially interfere with entry of the upper section into the food item, but securely grasp the central core section so the support stick is not easily disengaged therefrom while the food product is being eaten. The arms can be in a generally U-shaped configuration. The food product of the present invention comprises a food item, particularly a stone or pome fruit, that is securely supported by the above-described support stick. A method of making the food product comprises the steps of providing a food item having a central core section and then inserting the above-described stick into the food item to securely grasp the central core section. If desired, the food item can then be frozen to provide a frozen, healthy, completely natural treat.

Accordingly, the primary objective of the present invention is to provide a food product and support stick therefor that provides the advantages discussed above and that overcomes the disadvantages and limitations associated with presently available stick-based food products.

It is also an important objective of the present invention to provide a food product that utilizes an improved support stick which is suitable for securely grasping the center core section of the food item and which will not be easily separated from the food item while it is being eaten.

It is also an important objective of the present invention to provide an improved support stick that can be easily inserted into a food item to securely grasp the center core section, particularly the pit of stone fruit, of the food item and hold onto it while the food item is being eaten.

It is also an important objective of the present invention to provide an improved support stick that has an upper section with two or more upwardly extending arms configured to securely grasp the center core section of a food item and a lower section extending out of the food item and suitable for use as a handle.

The above and other objectives of the present invention will be explained in greater detail by reference to the attached figures and the description of the preferred embodiment which follows. As set forth herein, the present invention resides in the novel features of form, construction, mode of operation and combination of processes presently described and understood by the claims.

### BRIEF DESCRIPTION OF THE DRAWINGS

In the drawings which illustrate the best modes presently contemplated for carrying out the present invention:

FIG. 1 is a cross sectional view of the food product of the present invention utilizing the improved support stick configured according to one embodiment of the present invention to hold a stone fruit;

FIG. 2 is a front view of the improved support stick of the present invention;

FIG. 3 is a side view of the support stick of FIG. 2;

FIG. 4 is a cross sectional view of the food product of the present invention utilizing the improved support stick configured according to one embodiment of the present invention to hold a pome fruit;

FIG. 5 is a cross-sectional view of an alternative food product made from dried fruit with the central core section therein and a support stick configured to grasp the central core section;

FIG. 6 is a cross-sectional view of another alternative food product made from dried fruit compressed around a support stick; and

FIG. 7 is a cross-sectional view of yet another alternative food product made from a support stick inserted into a compressed mass of dried fruit.

### DETAILED DESCRIPTION OF THE PREFERRED EMBODIMENTS

With reference to the figures where like elements have been given like numerical designations to facilitate the reader's understanding of the present invention, and particularly with reference to the embodiments of the food product and support stick therefor of the present invention illustrated in the figures, the preferred embodiments of the present invention are set forth below. The enclosed figures and drawings are merely illustrative of the preferred embodiments and represent several different ways of configuring the present invention. Although specific components, materials, configurations and uses of the present invention are illustrated and set forth in this disclosure, it should be understood that a number of variations to the components and to the configuration of those components described herein and in the accompanying figures can be made without changing the scope and function of the invention set forth herein.

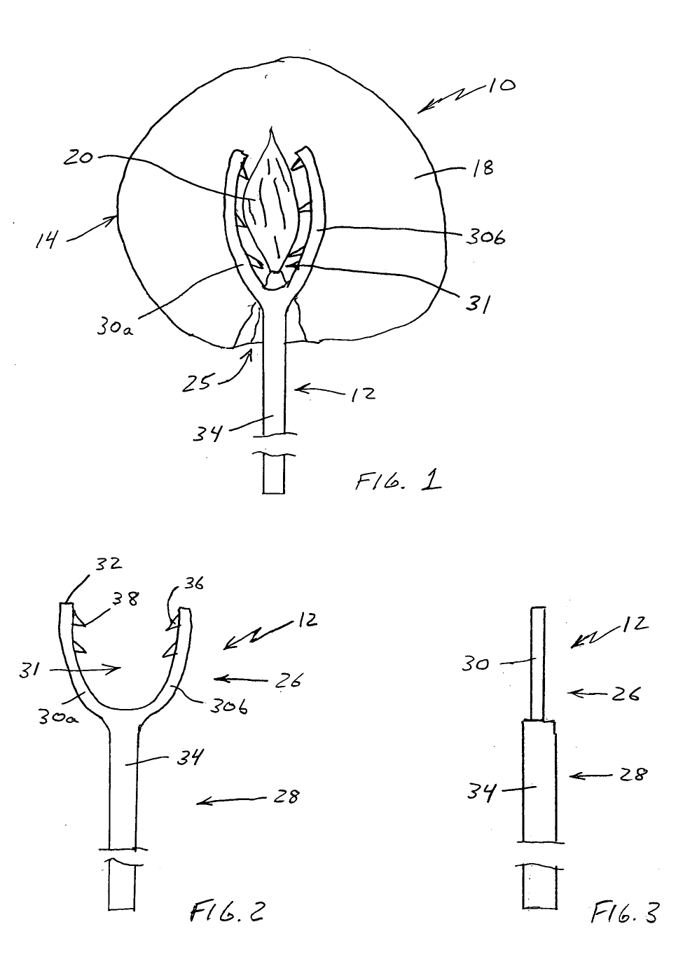

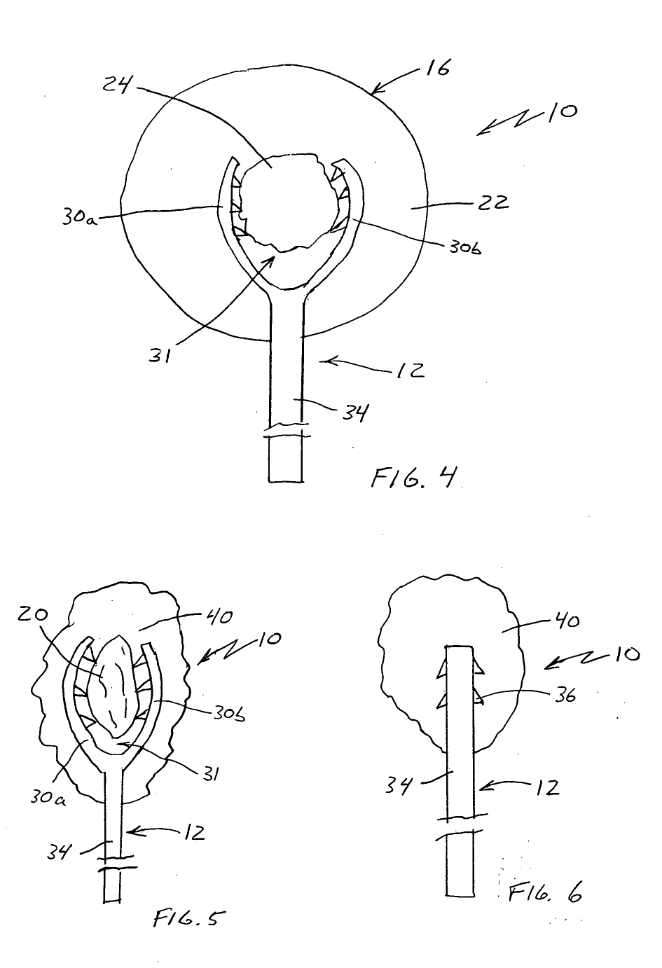

The food product of the present invention, identified generally as 10 in FIGS. 1 and 4, is comprised of a specially configured support stick 12 inserted inside of a fresh stone fruit 14 or pome fruit 16, as shown respectively in FIGS. 1 and 4. Support stick 12 can also be utilized with other food items, including frozen, dried or reconstituted fruits and other foods that are suitable or desirable for eating on support stick 12. As shown in FIG. 1, stone fruit 14 generally has a fleshy fruit portion 18 tightly surrounding a hard center core section (or pit) 20. Pome fruit 16, shown in FIG. 4, has a fleshy fruit portion 22 surrounding a semi-solid center core section 24. As shown in FIGS. 1 and 4, support stick 12 is inserted into food item 14 or 16 to form food product 10 by securely grasping the center core section 20 or 24 of the food item so the consumer can hold onto support stick 12 while eating the edible fleshy fruit portion 18 or 22 of the food item 14 or 16. As stated above, food item 14 or 16 can be fresh or it can be served in a frozen or dried condition.

In the preferred embodiment of the food product 10 of the present invention, support stick 12 should be inserted into food items 14 and 16 in a manner that results in the most beneficial support for support stick 12 in food item 14 or 16. The natural configuration for certain food items will suggest support stick 12 be inserted in one end or one side of that food item such that the food item itself will provide some support for support stick 12. For instance, with regard to stone fruit 14 or pome fruit 16, it will generally be beneficial to insert support stick 12 through the stem end 25 of the fruit 14 or 16. This is because most fruit, such as stone fruit 14 and pome fruit 16, are more fibrous around the stem area than in other places and, as a result, will tend to hold onto support stick 12 more firmly, providing a more solid food product 10. Although inserting support stick 12 through the stem end of fruits 14 and 16 will generally be preferred, it may not always be necessary or desired (for other reasons), depending on the particular food item.

As shown in the figures, support stick 12 of the present invention, best shown in FIG. 2, generally comprises an upper section 26 configured to be substantially inserted inside food item 14 or 16 and a lower section 28 configured to be substantially located outside of food item 14 or 16. Upper section 26 of support stick 12 has two or more generally upwardly extending arms 30, shown as 30a and 30b in FIG. 2, which are configured to grasp the central core sections 20 or 24 of food items 14 or 16 in chamber 31 formed by arms 30a and 30b. In the preferred embodiment of the present invention, two arms 30 are utilized and they are both configured to be arched outwardly in the middle and then curved inwardly at upper end 32 of support stick 12, such that they form a somewhat curved U-shape as shown in FIG. 2. Lower section 28 of support stick 12 comprises handle 34 suitable sized and shaped to be held by a person while eating the food item 14 or 16 portion of food product 10.

Support stick 12 can be made out of a variety of materials and configured in a variety of sizes and shapes. For instance, support stick 12 can be made out of molded resin or plastic, various metals, composites, wood and any other materials suitable for the intended purpose of supporting food item 14 or 16. In the preferred embodiment, upper section 26 of support stick 12 is made out of materials that allow arms 30a and 30b to be somewhat elastic and maintain residual tension (i.e., elastic memory) therein such that when upper section 26 is inserted into food item 14 or 16 the arms 30a and 30b will open to spread about center core section 20 or 24 and then close around the central core section 20 or 24 to securely receive central core section 20 or 24 in chamber 31 as upper end 32 passes along central core section 20 or 24. A preferred material, due to its generally elastic properties, cost and ease of manufacturing, is a food-grade plastic that is suitable for molding.

In a preferred embodiment of the support stick 12 of the present invention, upper section 26 further comprises one or more inwardly projecting grasping members 36 attached to, mounted on or integral with arms 30, as shown in FIGS. 2 and 4 on arms 30a and 30b. The preferred embodiment comprises a plurality of grasping members 36 on arms 30a and 30b that are directed inwardly of chamber 31. As shown, grasping members 36 can be a barb or barb-like structure that is mounted onto arms 30a and 30b to more securely grasp the central core section 20 or 24 of food item 14 or 16 in chamber 31. In the preferred embodiment, grasping members 36 have a pointed or sharp inwardly directed end 38 configured to engage central core section 20 or 24 and securely hold support stick in place inside food item 14 or 16 while it is being eaten. As known to those skilled in the art, it is also preferred that grasping members 36 be generally inwardly and downwardly directed, as shown in FIG. 2, so that grasping members 36 can more easily slide along central core section 20 or 24 as support stick is placed inside food item 20 or 24 and, once inside such that upper end 32 is at central core section 20 or 24, then grasp central core section 20 or 24 when the direction is reversed (i.e., end 38 of grasping members 36 engage central core section 20 or 24). This type of configuration is particularly beneficial for stone fruit 14 having a pit as the central core section 20. Most pits 20 have a plurality of ridges and valleys on their surface that can be beneficially engaged by end 38 of grasping members 36. Various configurations of grasping members 36 would be suitable for the present invention, including those that are more hook or hook-like shaped.

Different sizes of support stick 12 will generally be required for different types and sizes of food items 14 or 14. For instance peaches and nectarines will generally require larger support sticks 12, with regard to both the arms 30 and chamber 31 of upper section 26 and handle 34 of lower section 28, than will be required for plums and cherries. The size determination for support stick 12, particularly with regard to arms 30 and chamber 31, is somewhat dependant on the size of central core section 20 or 24, and the overall diameter, weight and height of food item 14 or 16. The size determination for handle 34 will generally be most dependant on the size and weight of food item 14 or 16. At the very least, support stick should come in a small and a large version for smaller and larger food items 14 and 16. For both the smaller and larger versions, as well as any other sizes offered, grasping members 36 should be sized and configured in a manner that most beneficially grabs central core section 20 or 24 of the particular food item 14 or 16 for which support stick 12 is to be utilized. If desired, upper end 32 of support stick 12 can be configured with pointed ends or otherwise configured to facilitate entry of arms 30 into food item 14 or 16 and passage therethrough. Handle 34 should be sized and configured to be easy to hold and of sufficient strength to hold the food item 14 or 16 for which it will be utilized. A too small of handle 34 could bend or break from the weight of food item 14 or 16 and a too large of handle 34 could overwhelm the food item 14 or 16, creating a visually unappealing food product 10.

In use, food product 10 of the present invention can comprise any type of food item that may be beneficially served on a stick-type of member. In the preferred embodiment, the food item is a fresh, frozen or dried fruit, such as those shown as 14 and 16 in the figures. For fresh fruit, support stick 12 is inserted into the fruit 14 or 16 such that arms 30 slide along central core section 20 or 24. As upper end 32 comes to central core section 20 or 24, the elastic nature of arms 30a and 30b will allow them to spread slightly so arms 30 will go around central core section 20 or 24 to generally place central core section 20 or 24 into chamber 31. Because grasping members 36 are generally inwardly and downwardly projecting, they will slide along central core section 20 or 24 and then engage central core section 20 or 24 to prevent support stick 12 from being easily removed from food item 14 or.16, particularly when edible portion 18 or 22 of food item 14 or 16 is being eaten. For a frozen treat, fresh food product 10 is placed into a freezer or freezer-like apparatus to freeze edible portion 18 or 22 of food item 14 or 16. Once frozen, food product 10 can be served and eaten in much the same way as ice cream or other frozen deserts, except it will be 100% natural and much more healthy.

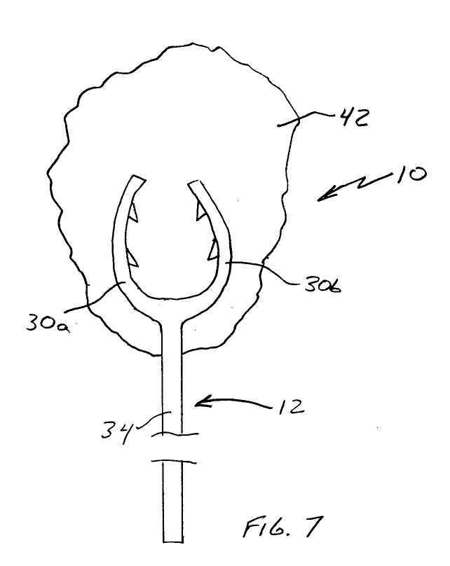

For dried fruit, shown as 40 in FIG. 5, the stone fruit 14 or pome fruit 16 can be dried as a whole unit (i.e., with central core section 20 or 24 still inside) and then support stick 12 can be inserted as described above for fresh food items 14 or 16. Not having to remove the pit prior to drying the fruit 14 or 16 can significantly reduce the cost of preparing such foods for consumption. In another embodiment, shown in FIG. 6, food product 10 can comprise dried fruit 40, which can be comprised of various combinations of different dried fruits, on support stick 12 without any central core section 20 or 24. This food product 10 can utilize dried fruit 40 formed in the presently available manner (i.e., first removing central core sections 20 or 24 and then drying the fruit) and then compressing the dried fruit 40, or combinations of dried fruit 40, around support stick 12. Because of the compressing of dried fruit 40 around support stick 12, the support stick 12 can be configured with an upper section 26 with only a single arm 30. In another embodiment of food product 10 with dried fruit 40, central core sections 20 and/or 24 are removed from dried fruit 40 (including combinations of dried fruit) and then the dried fruit 40 is formed into a mass of dried fruit 42 in which support stick 12 is then inserted to form food product 10, as shown in FIG. 7. If desired, dried fruit 40 can be compressed into the mass of dried fruit 42 to provide a better stick 12 to fruit 42 connection.

In another alternative embodiment of food product 10, the central core section 20 or 24 of food item 14 or 16 can be removed, as well as any skin, seeds or other parts of food item 14 or 16 as desired, and the edible portion 18 or 22 can be ground into a pulp. The pulp can be placed into a mold having support stick 12 placed therein and then frozen to form a 100% natural fruit treat on a stick. If desired, a preservative such as citric acid (i.e., lemon juice) can be added to the grinded up pulp to keep the natural color longer.

While there are shown and described herein certain specific alternative forms of the invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to any dimensional relationships set forth herein and modifications in assembly, materials, size, shape and use. In even more particularity, it should be noted that support stick 12 can be made with more than two arms 30, such as using support stick 12 with three, four or even six arms 30, and that support stick 12 may be adaptable to food items other than the stone fruit 14 and pome fruit 16 described herein.

1. A support stick for a food item having a central core section, said support stick comprising:
an upper section having two or more generally upwardly extending arms forming a chamber therebetween, said two or more arms configured to be inserted into said food item and securely grasp said central core section of said food item; and
a lower section abutting said upper section, at least a portion of said lower section configured to extend outwardly from said food item, said lower section comprising a handle.

2. The support stick according to claim 1, wherein said food item is a stone fruit.

3. The support stick according to claim 1, wherein said food item is a pome fruit.

4. The support stick according to claim 1, wherein at least one of said two or more arms is elastic.

5. The support stick according to claim 1, wherein at least one of said two or more arms has one or more generally inwardly directed grasping members thereon.

6. The support stick according to claim 5, wherein said one or more grasping members are generally angled downward to improve grasping of said central core section by said two or more arms.

7. The support stick according to claim 6, wherein at least one of said two or more arms is elastic.

8. The support stick according to claim 1, wherein said two or more arms are in a generally U-shaped configuration.

9. A support stick for a food item having a central core section, said support stick comprising:
an upper section having two or more generally upwardly extending arms in a generally U-shaped configuration forming a chamber therebetween, at least one of said two or more arms being elastic, said two or more arms configured to be inserted into said food item and securely grasp said central core section of said food item; and
a lower section abutting said upper section, at least a portion of said lower section configured to extend outwardly from said food item, said lower section comprising a handle.

10. The support stick according to claim 9, wherein at least one of said two or more arms has one or more generally inwardly directed grasping members thereon.

11. A food product, comprising:
a food item having a central core section; and
a support stick attached to said food item, said support stick comprising an upper section and a lower section, said upper section having two or more generally upwardly extending arms forming a chamber therebetween, said two or more arms configured to be inserted into said food item and securely grasp said central core section of said food item, said lower section abutting said upper section, at least a portion of said lower section configured to extend outwardly from said food item, said lower section comprising a handle.

12. The support stick according to claim 11, wherein at least one of said two or more arms is elastic.

13. The support stick according to claim 11, wherein at least one of said two or more arms has one or more generally inwardly directed grasping members thereon.

14. The support stick according to claim 13, wherein said one or more grasping members are generally angled downward to improve grasping of said central core section by said two or more arms.

15. The support stick according to claim 14, wherein at least one of said two or more arms is elastic.

16. The support stick according to claim 11, wherein said two or more arms are in a generally U-shaped configuration.

17. A method of making a food product, comprising the steps of:
providing a food item having a central core section; and
inserting a support stick into said food item to securely grasp said central core section of said food item, said support stick comprising an upper section and a lower section, said upper section having two or more generally upwardly extending arms forming a chamber therebetween for securely grasping said central core section, said lower section abutting said upper section, at least a portion of said lower section configured to extend outwardly from said food item, said lower section comprising a handle.

18. The support stick according to claim 17, wherein at least one of said two or more arms is elastic.

19. The support stick according to claim 17, wherein at least one of said two or more arms has one or more generally inwardly directed grasping members thereon.

20. The support stick according to claim 19, wherein said one or more grasping members are generally angled downward to improve grasping of said central core section by said two or more arms.

21. The support stick according to claim 20, wherein at least one of said two or more arms is elastic.

22. The support stick according to claim 17, wherein said food item is dried prior to said providing step.

23. The support stick according to claim 17 further comprising the step of freezing said food product after said inserting step.

24. A method of making a food product, comprising the steps of:
providing a food item having a central core section;
removing said central core section from said food item;
drying said food item to form a dried fruit; and
compressing said dried fruit around a support stick, said support stick comprising an upper section and a lower section, at least a portion of said lower section configured to extend outwardly from said dried fruit, said lower section comprising a handle.

25. The support stick according to claim 24, wherein said upper section has two or more generally upwardly extending arms forming a chamber therebetween.

26. The support stick according to claim 25, wherein at least one of said two or more arms is elastic.

27. The support stick according to claim 25, wherein at least one of said two or more arms has one or more generally inwardly directed grasping members thereon.

28. A method of making a food product, comprising the steps of:
providing a food item having a central core section;
removing said central core section from said food item;
drying said food item to form a dried fruit; and
inserting a support stick into said dried fruit, said support stick comprising an upper section and a lower section, at least a portion of said lower section configured to extend outwardly from said dried fruit, said lower section comprising a handle.

29. The support stick according to claim 28 further comprising the step of compressing said dried fruit into a mass of dried fruit prior to said inserting step, wherein said inserting step inserts said support stick into said mass of dried fruit.

30. The support stick according to claim 28, wherein said upper section has two or more generally upwardly extending arms forming a chamber therebetween.

31. The support stick according to claim 30, wherein at least one of said two or more arms is elastic.

32. The support stick according to claim 31, wherein at least one of said two or more arms has one or more generally inwardly directed grasping members thereon.
